(19) United States
(12) Patent Application Publication
(10) Pub. No.: US 2002/0023191 A1
(43) Pub. Date: Feb. 21, 2002

(54) Semiconductor memory device and memory system using the same

(75) Inventor: Yoshio Fudeyasu, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/769,417

(22) Filed: Jan. 26, 2001

(30) Foreign Application Priority Data
Aug. 21, 2000 (JP) 2000-249229 (P)

(51) Int. Cl. G06F 13/00

(52) U.S. Cl. 711/104

(57) ABSTRACT

A bus for transferring write data is provided separately from a bus for transferring read data, and the respective widths of these buses are made different from each other. Thus, bus utilization efficiency and data transfer efficiency are improved.

### BACKGROUND OF THE INVENTION

1. Field of the Invention

The present invention generally relates to a semiconductor memory device and a memory system using the same, and more particularly, to an arrangement for data transfer.

2. Description of the Background Art

FIG. 21 is a diagram schematically showing the structure of a conventional memory system. In FIG. 21, the memory system includes a memory IC (Integrated Circuit) 910 and a memory controller 900 for controlling access to memory IC 910 according to an access request from a processor such as CPU (Central Processing Unit) to memory IC 910. An operation control bus 912 and a data bus 914 are provided between memory controller 900 and memory IC 910. Operation control bus 912 transfers a control signal CTL and an address signal ADD from memory controller 900 to memory IC 910. Data bus 914 transfers write data to memory IC 910 and read data from memory IC 910 between memory controller 900 and memory IC 910.

Memory controller 900 transfers the control signal CTL and address signal ADD required for data access through operation control bus 912 to memory IC 910. In writing data, memory controller 900 transfers the write data to memory IC 910 through data bus 912. In reading data, memory IC 910 performs memory-cell selection and data read operation according to the control signal CTL and address signal ADD applied through operation control bus 912, and transfers the read data to memory controller 900 through data bus 914. Thus, bi-directional data transfer is performed on data bus 914. More specifically, on data bus 914, the write data is transferred from memory controller 900 to memory IC 910, and the read data is transferred from memory IC 910 to memory controller 900. On the other hand, operation control bus 912 is a unidirectional bus that merely transfers the control signal and address signal from memory controller 900 to memory IC 910.

FIG. 22 is a timing chart showing a sequence of an access to memory IC 910 shown in FIG. 21. Memory IC 910 inputs/outputs (transfers) the data and takes in the control/address signals both in synchronization with a clock signal CLK.

It is now assumed that a write command CW instructing data writing is applied from memory controller 900 to memory IC 910 in clock cycle #A. Herein, the write command CW includes both the control signal CTL and the address signal ADD shown in FIG. 21. In writing data, write data D0 is transferred from memory controller 900 to memory IC 910 through data bus 914 simultaneously with the write command CW. If the burst length is four, write data D0 to D3 are transferred and written to memory IC 910 through data bus 914 sequentially, starting from clock cycle #A, in synchronization with the clock signal CLK.

Then, in clock cycle #B, a read command CR instructing data reading is applied from memory controller 900 to memory IC 910. Herein, the read command CR also includes both the control signal CTL and the address signal ADD. In reading data, memory IC 910 must internally performs memory-cell selection and data read operation after the reception of the read command CR. Therefore, after the period called column latency, data Q0 to Q3 are sequentially read from memory IC 910 and transferred to memory controller 900 in synchronization with the clock signal CLK. This data read operation is also exemplarily shown for the burst length of four.

Data bus 914 is a bi-directional data bus through which the write data D or the read data Q can merely be transferred at a certain point of time. In order to prevent conflict (collision) between the write data and the read data on bi-directional data bus 914, the data bus has an unoccupied time period. Particularly when a plurality of memory ICs 910 are connected in parallel to bi-directional data bus 914, each memory IC 910 has a different distance to memory controller 900, whereby the difference in data propagation time is produced. Therefore, the data bus must have an unoccupied time period in view of such a difference in time. In addition, in the case where the write/read command is applied in writing/reading data, such a command is transferred only when necessary. Accordingly, operation control bus 912 is utilized less frequently and less efficiently than bi-directional data bus 914.

FIG. 23 is a timing chart representing an operation of the memory IC in transferring commands and data in packets. As shown in FIG. 23, operation control bus 912 is divided into two buses: a row address bus for transmitting a command and row address related to a row selection, and a column address/command bus for transmitting a command and column address related to the column selection. The row address and column address are transmitted in a time-division-multiplexed manner. In synchronization with the clock signal CLK, an active command package ACT for activating a row selection operation is applied over, for example, four clock cycles. In response to the active command package ACT, memory IC 910 performs the row selection operation according to an address signal contained in the package.

Then, a write command packet WR instructing data writing is applied through the column address/command bus. In this packet signal/data transfer, write data D is applied after a prescribed number of clock cycles (six clock cycles in FIG. 23) since the write command packet WR is applied (in consideration of the internal write-operation latency). Following the write command packet WR, a read command packet RD instructing data reading is applied. Read data Q is output after a prescribed number of clock cycles (six clock cycles in FIG. 23) since the read command packet RD is applied. After the data read operation is performed, a precharge command packet PRE is applied through the row address bus. Memory IC 910 is restored to the precharged state according to the precharge command packet PRE.

Even in the case of such signal/data packet transfer, an access command packet instructing data writing/reading is transferred only when the data is to be written/read. Therefore, operation control bus 912 is not utilized efficiently.

In order to improve the bus utilization efficiency and achieve high-speed access, a plurality of banks are provided in memory IC 910 and the banks are sequentially accessed in an interleaved manner. However, the possible number of banks provided is limited, and a single bank can be maintained in the selected state at most for a time period predetermined by the data retention time of a DRAM cell. Therefore, there is a limitation on sequential access through a number of banks provided as many as possible.

Moreover, since the write data D and read data Q are both transferred through data bus 914, data bus 914 has an unoccupied time period in order to prevent data conflict. In such a packet scheme memory system as well, a plurality of memory ICs are provided in parallel. Therefore, in view of the difference in signal propagation delay time resulting from the difference in interconnection length of the data bus, the minimum required time slot (unoccupied time) must be provided between the packets for data reading/writing, in order to prevent the data collision. Accordingly, in the conventional memory system, the operation control bus and data bus are not utilized efficiently, whereby data transfer cannot be performed at a high speed.

### SUMMARY OF THE INVENTION

It is an object of the present invention to provide a semiconductor memory device capable of performing efficient data transfer to achieve improved bus utilization efficiency.

It is another object of the present invention to provide a memory system capable of performing efficient data transfer with improved bus utilization efficiency.

A semiconductor memory device according to the present invention includes a plurality of input terminals for receiving write data, a control signal and an address signal, and at least one output terminal for outputting read data. The number of bits of the write data is made different from that of the read data.

A memory system according to the present invention includes a memory for storing information, a memory controller for controlling access to the memory, a first unidirectional bus for transferring write data, a control signal and an address signal from the memory controller to the memory, and a second unidirectional bus for transferring read data from the memory to the memory controller. The number of bits of the read data is different from that of the write data.

According to the present invention, the number of bits of the write data is made different from that of the read data. In the case where data such as write data was transferred, the number of bits of read data is increased so that the bus lines are utilized as many as possible. Thus, the data can be transferred by efficiently utilizing the bus according to the direction and frequency of data transfer. As a result, high-speed data transfer can be implemented.

In particular, by forming the bus for transferring the write data and the bus for transferring the control signal and address signal by the common bus lines, the bus can be utilized more efficiently for data transfer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing the structure of a memory system according to Embodiment 1 of the present invention.

FIG. 2 is a diagram showing one example of a data and signal transfer sequence according to Embodiment 1 of the present invention.

FIG. 3 is a diagram showing one example of a transfer sequence of a control signal, write data and read data according to Embodiment 1 of the present invention.

FIG. 4 is a diagram schematically showing the overall structure of a memory IC according to Embodiment 1 of the present invention.

FIG. 5 is a diagram schematically showing the structure of a bit-width expansion circuit shown in FIG. 4.

FIG. 6 is a timing chart representing an operation of the bit-width expansion circuit shown in FIG. 5.

FIG. 7A is a diagram showing one example of the structure of a bit-width reduction circuit shown in FIG. 4, and FIG. 7B is a timing chart representing an operation of the bit-width reduction circuit shown in FIG. 7A.

FIG. 8 is a timing chart showing one example of another operation sequence of the memory IC shown in FIG. 4.

FIG. 9 is a diagram showing one example of the structure of a memory controller according to Embodiment 1 of the present invention.

FIG. 10 is a diagram showing one example of the structure of a bit-width reduction circuit shown in FIG. 9.

FIG. 11 is a diagram showing one example of the structure of a bit-width expansion circuit shown in FIG. 9.

FIG. 12 is a diagram schematically showing a modification of the memory system according to Embodiment 1 of the present invention.

FIG. 13 is a timing chart showing a data-transfer-operation sequence of the memory system shown in FIG. 12.

FIG. 14 is a diagram schematically showing the structure of a main part of a memory IC according to Embodiment 2 of the present invention.

FIG. 15 is a diagram schematically showing the structure of an input buffer circuit and a bit-width conversion circuit shown in FIG. 14.

FIG. 16 is a diagram showing one example of the structure of a bus-line selection circuit shown in FIG. 15.

FIG. 17 is a diagram schematically showing the structure of a write transfer control circuit shown in FIG. 15.

FIG. 18 is a diagram schematically showing the structure of a bit-width conversion circuit and an output buffer circuit shown in FIG. 14.

FIG. 19 is a diagram showing one example of the structure of a bus-line selection circuit shown in FIG. 18.

FIG. 20 is a diagram schematically showing the structure of a memory controller according to Embodiment 2 of the present invention.

FIG. 21 is a diagram schematically showing the structure of a conventional memory system.

FIG. 22 is a timing chart representing an operation of the conventional memory system.

FIG. 23 is a diagram showing one example of another data transfer sequence of the conventional memory system.

### DESCRIPTION OF THE PREFERRED EMBODIMENTS

### Embodiment 1

FIG. 1 is a diagram schematically showing the structure of a memory system according to Embodiment 1 of the present invention. In FIG. 1, the memory system includes a memory controller 1 and a memory IC 2. Memory controller 1 transfers a control signal CTL, an address signal ADD and write data D to memory IC 2 through a first bus 3. Memory IC 2 transfers read data Q to memory controller 1 through a second bus 4. First bus 3 has an M-bit width, and second bus 4 has an N-bit width. The buses 3 and 4 have different bit widths (M≠N). Each of the buses 3 and 4 is a unidirectional bus that transfers the signal/data only in one direction. In first bus 3, the control signal CTL and address signal ADD are transferred on the common bus lines with the write data D. Respective bit widths of the write data D and read data Q are determined according to the specification of memory IC 2 so that buses 3 and 4 can be utilized with the highest efficiency.

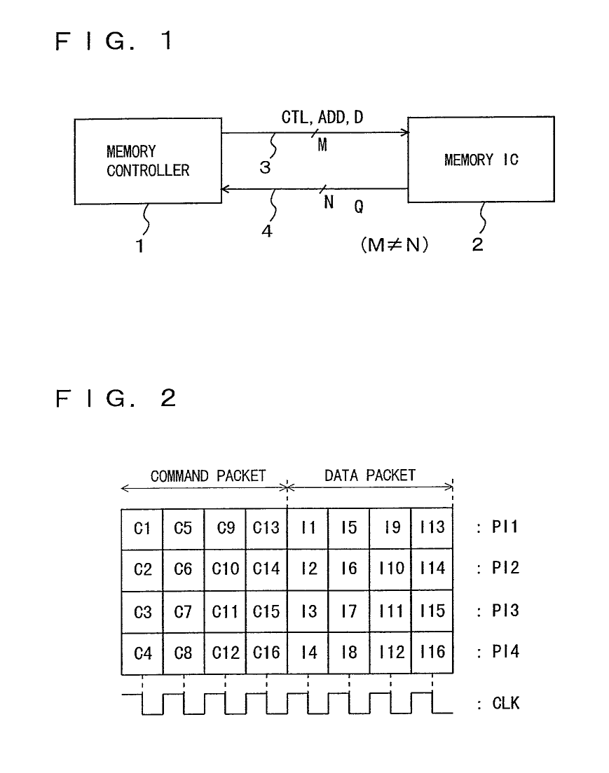

It is now assumed that input pins of memory IC 2 coupled to first bus 3 include 4-bit input pins PI1 to PI4, as shown in FIG. 2, and that a command packet including an address signal is a 16-bit packet and a data packet is also a 16-bit packet. In this case, a command packet instructing data writing is first transferred in four bits in synchronization with a clock signal CLK, as shown in FIG. 2. Accordingly, 16 bits C1 to C16 of the command packet are transferred from memory controller 1 through first bus 3 to memory IC 2 over four cycles of the clock signal CLK. Then, write data D is transferred through the same bus 3. The write data D is a 16-bit data, and 16 bits I1 to I16 of the write data D are similarly transferred in four bits through first bus 3 to memory IC 2 in synchronization with the clock signal CLK. Accordingly, eight clock cycles are required in total for the data writing.

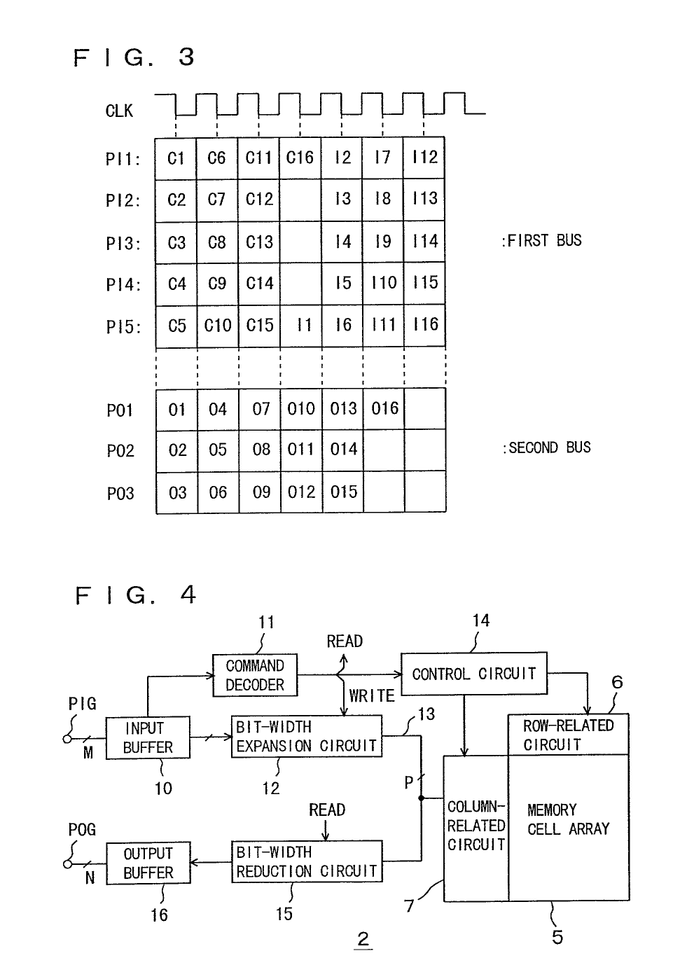

It is now considered that first bus 3 is set to have a 5-bit width, and second bus 4 is set to have a 3-bit width, as shown in FIG. 3. The total number of bits of first and second buses 3 and 4 remains unchanged and is eight. The first bus 3 has a 5-bit width, and therefore, the 16-bit command packet is transferred over four clock cycles. In this case, by transferring the write data bit I1 together with the command address bit C16 in the fourth clock cycle, the data packet can be transferred substantially over three clock cycles. Accordingly, the command packet and data packet can be transferred over seven clock cycles in total. At this time, 16-bit data Q is sequentially transferred in three bits from output terminals PO1 to PO3 of memory IC 2 coupled to second bus 4. Therefore, in parallel with the data writing, 16 bits O1 to O16 of the read data Q can be transferred to memory controller 1 through second bus 4. Thus, an unoccupied time period of first and second buses 3 and 4 can be reduced.

In reading the data, a read command packet instructing the data reading is transferred before the command packet instructing the data reading. The data bits O1 to O16 are read in three bits from memory IC 2 the column latency after the read command packet is transferred. In other words, in memory IC 2, a data input circuit and a data output circuit operate simultaneously. Memory IC 2 internally performs the memory-cell selection, write operation and read operation according to the sequence in which the commands are applied. Memory IC 2 simply performs the data writing/reading simultaneously in its interface circuit coupled to buses 3 and 4.

FIG. 4 is a diagram schematically showing the structure of memory IC 2 shown in FIG. 1. In FIG. 4, memory IC 2 includes a memory cell array 5 having a plurality of memory cells arranged in rows and columns, a row-related circuit 6 for performing an operation associated with row selection of memory cell array 5, and a column-related circuit 7 for performing an operation associated with column selection of memory cell array 5. Memory cell array 5 is provided with word lines corresponding to the memory cell rows, and bit lines corresponding to the memory cell columns.

Row-related circuit 6 includes a row decoder for decoding a row address, a word-line drive circuit for driving a word line corresponding to an addressed row into the selected state according to a decode signal from the row decoder, a precharging/equalizing circuit for precharging and equalizing a bit line to a prescribed voltage level, and a sense amplifier circuit for sensing, amplifying and latching selected memory cell data.

Column-related circuit 7 includes a column decoder for decoding a column address to produce a column selection signal, a write drive circuit for writing the data to a memory cell in a selected column, and a preamplifier for amplifying the data of a selected memory cell.

Memory IC 2 includes an input buffer 10 for receiving a command packet and write data from memory controller 1 through an input-pin terminal group PIG coupled to M-bit first bus 3, a command decoder 11 for decoding the command packet from input buffer 10 to produce an operation mode instructing signal designating an internal operation, a bit-width expansion circuit 12 for converting the M-bit data from input buffer 10 into P-bit write data according to a write operation mode instruction signal WRITE from command decoder 11 for transmission onto an internal data bus 13, a bit-width reduction circuit 15 for receiving P-bit internal read data from internal data bus 13 to convert the P-bit data read onto internal data bus 13 into N-bit data according to a read operation mode instructing signal READ from command decoder 11, an output buffer 16 for sequentially outputting the data from bit-width reduction circuit 15 through an N-bit output terminal group POG, and a control circuit 14 for producing a control signal required for the designated operation according to the operation mode instructing signal from command decoder 11. In FIG. 4, control circuit 14 is shown generating a control signal to row-related circuit 6 and column-related circuit 7. However, control circuit 14 may also apply an output enable signal to output buffer 16.

As shown in FIG. 4, bit-width expansion circuit 12 is utilized to convert, for example, the 16-bit write data, which is transmitted over four clock cycles as shown in FIG. 3, into 16-bit internal write data for transmission onto internal data bus 13 at a time (in the case of P=16). On the other hand, bit-width reduction circuit 15 reduces the bit width of the P-bit (=16-bit) data read onto internal data bus 13 to the bit width N (=3) of output terminal group POG, and sequentially transfers the resultant N-bit data to output buffer 16 according to the clock signal. Thus, by setting the respective bit widths of input-pin terminal group PIG and output-pin terminal group POG according to the specification of the memory IC, efficient data transfer can be achieved.

Internal data bus 13 has a 16-bit width, for example. Therefore, according to the applied command and under the control of control circuit 14, the data can be simultaneously written to or read from the 16-bit memory cells selected from memory cell array 5 according to the address signal included in the command packet.

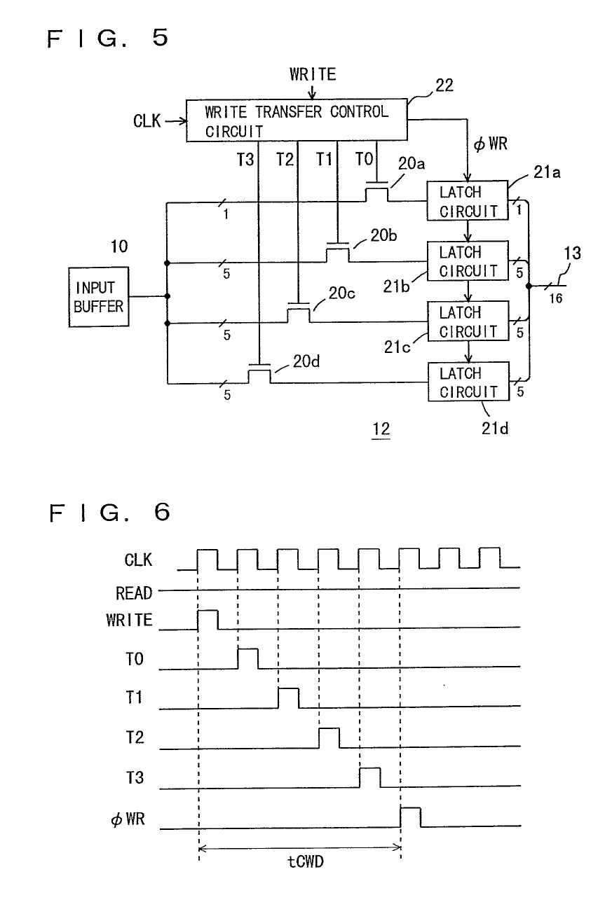

FIG. 5 is a diagram schematically showing the structure of bit-width expansion circuit 12 shown in FIG. 4. In FIG. 5, bit-width expansion circuit 12 includes a write transfer control circuit 22 for sequentially generating transfer clock signals T0 to T3 according to the clock signal CLK and the write operation mode instructing signal WRITE from command decoder 11 shown in FIG. 4, transfer gates 20a to 20d rendered conductive according to the respective transfer clock signals T0 to T3 from write transfer control circuit 22 for transferring the data bits from input buffer 10, and latch circuits 21a to 21d provided corresponding to the respective transfer gates 20a to 20d for latching the data bits transferred from the respective transfer gates 20a to 20d. These latch circuits 21a to 21d transfer the latched data bits in parallel onto internal data bus 13 in response to activation of a write activation signal φWR from write transfer control circuit 22. The data bits on internal data bus 13 are applied to the write driver included in column-related circuit 7 shown in FIG. 4.

In the case of the data bit structure as shown in FIG. 3, in bit-width expansion circuit 12 of FIG. 5, transfer gate 20a transfers 1-bit data, and latch circuit 21a latches and outputs the 1-bit data. Transfer gates 20b to 20d each transfer 5-bit data, and latch circuit 21b to 21d each latch and output 5-bit data. Transfer gate 20a is coupled to receive a predetermined data bit of the 5-bit outputs of input buffer 10. The other transfer gates 20b to 20d each are coupled to respective internal output nodes of input buffer 10. Now, the operation of bit-width expansion circuit 12 shown in FIG. 5 will be described with reference to the timing chart of FIG. 6.

When a write command packet is applied, command decoder 11 activates the write operation mode instructing signal WRITE according to a write command included in the write command packet. In response to activation of the write operation mode instructing signal WRITE, write transfer control circuit 22 sequentially activates the transfer clock signals T0 to T3 (i.e., drives them to H level) according to the clock signal CLK. Thus, transfer gates 20a to 20d are sequentially rendered conductive to transfer the data applied to input buffer 10, respectively so that the data are latched in the corresponding latch circuits 21a to 21d.

The write activation signal φWR is activated after a prescribed time tCW (CAS—write delay time) since activation of the write operation mode instructing signal WRITE. Latch circuits 21a to 21d responsively transmit the latched data bits in parallel onto internal data bus 13. Thus, the 1-bit data, 5-bit data, 5-bit data and 5-bit data transferred according to the transfer clock signals T0 to T3 are latched in latch circuits 21a to 21d respectively, and transferred in parallel onto 16-bit internal data bus 13. Memory-cell selection is performed according to an address signal included in the write command packet.

The write command packet and write data are serially applied to input buffer 10, and a write data packet is transferred following the write command packet. However, the write data packet may be applied a prescribed time after the write command packet is applied. Since the time period between the write data packet and the write command packet is predetermined, the transfer clock signals T0 to T3 are sequentially activated after an elapse of a prescribed time since activation of the write operation mode instructing signal WRITE, under the control of write transfer control circuit 22. This is merely implemented by that the activation timing of the transfer clock signals T0 to T3 is delayed for the prescribed time.

The latch circuits 21a to 21d may have any structure as long as they latch the data bits applied through the respective transfer gates 20a to 21d and transfer the latched data bits according to the write activation signal φWR. For example, each of latch circuits 21a to 21d can be formed by a transfer gate and an inverter latch circuit.

Provided that the bit width of write data is fixed, write transfer control circuit 22 may have any structure as long as it generates the clock signal CLK for a prescribed clock cycle period according to the write operation mode instructing signal WRITE. For example, write transfer control circuit 22 can include a flip-flop that is set in response to activation of the write operation mode instruction signal WRITE and is reset four clock cycles thereafter, so that the transfer clock signals T0 to T3 are produced by the AND operation of an output signal of the flip-flop and the clock signal CLK.

In FIG. 6, the transfer clock signals T0 to T3 are generated in synchronization with the rise of the clock signal CLK. This is because sampling of the external command and data bits is performed in synchronization with the fall of the clock signal CLK, as shown in FIG. 3. However, the transfer clock signals T0 to T3 may be produced in synchronization with the fall of the clock signal CLK.

In the case of a DDR (Double Data Rate) mode in which the data packet and command packet are transferred by using both rising and falling edges of the clock signal CLK, the structure shown in FIG. 5 can be used also in the DDR mode as long as input buffer 10 performs sampling of the signal/data bits at the rising and falling edges of the clock signal CLK and outputs the sampled signal/data bits in parallel at the rising or falling edge of the clock signal CLK.

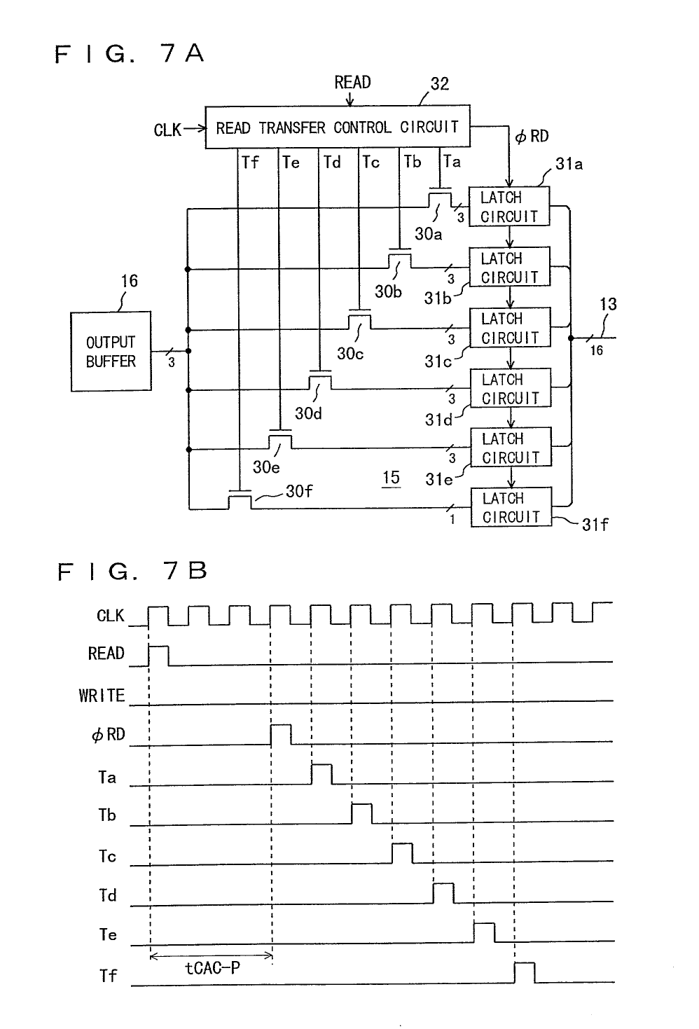

FIG. 7A is a diagram schematically showing the structure of bit-width reduction circuit 15 shown in FIG. 4. In FIG. 7A, bit-width reduction circuit 15 includes latch circuits 31a to 31f provided for different bus lines of internal data bus 13, transfer gates 30a to 30f provided corresponding to the respective latch circuits 31a to 31f for transferring latch data of the respective latch circuits 31a to 31f to output buffer 16 according to respective transfer clock signals Ta to Tf, and a read transfer control circuit 32 for producing the transfer clock signals Ta to Tf and applying a read activation signal φRD to latch circuits 31a to 31f according to the read operation mode instructing signal READ and the clock signal CLK.

For example, latch circuits 31a to 31e each has a 3-bit width in order to implement the data transfer shown in FIG. 3, and latch circuit 31f has a 1-bit width. Output buffer 16 sequentially transfers 3-bit data applied from transfer gates 30a to 30f to the 3-bit data output terminal group. Now, the operation of bit-width reduction circuit 15 shown in FIG. 7A will be described with reference to the timing chart of FIG. 7B.

First, when the read command packet is applied, the read operation mode instructing signal READ is activated. In response to activation of the read operation mode instructing signal READ, read transfer control circuit 32 counts a prescribed time period (column latency minus one clock cycle). After the prescribed time period, read transfer control circuit 32 activates the read activation signal φRD. This cycle period of column latency minus one (tCAC−1) is determined from the time required for internal column selection from the memory cell array and internal transfer of data of the selected memory cells (including activation of the preamplifier).

Latch circuits 31a to 31f latch the 16-bit data applied to internal data bus 13 by 3 bits, 3bits, 3 bits, 3 bits, 3 bits and 1 bit, respectively, according to activation of the read activation signal φRD.

Then, read data control circuit 32 sequentially activates the transfer clock signals Ta to Tf from the following clock cycle. The data latched in latch circuits 31a to 31f are sequentially transferred to output buffer 14 through the respective transfer gates 30a to 30f. Output buffer 16 sequentially outputs the 3-bit data.

Accordingly, in the structure shown in FIG. 7A, the 16-bit data is converted into the 3-bit data, which are sequentially output in a serial manner.

The transfer clock signals Ta to Tf are generated in synchronization with the clock signal CLK. However, these transfer clock signals Ta to Tf may have a phase difference of 180° with respect to the clock signal CLK. Output buffer 16 sequentially transfers the data bits in synchronization with the rise of the clock signal CLK. Output buffer 16 may be structured to transfer the data bits in the DDR mode. In the DDR-mode transfer, the transfer clock signals Ta to Tf are activated with their phases being shifted by a half clock cycle of the clock signal CLK. Alternatively, the transfer clock signals Ta to Tf may be grouped in pairs to be simultaneously activated in pairs, so that output buffer 16 converts the 6-bit data into 3-bit data and transfers the 3-bit data in synchronization with the rising and falling edges of the clock signal CLK (output buffer 16 performs parallel/serial conversion of 6-bit/3-bit data). The phase relation between the clock signal CLK and the read data bits in such data transfer need only be determined as appropriate according to the specification of the memory IC used.

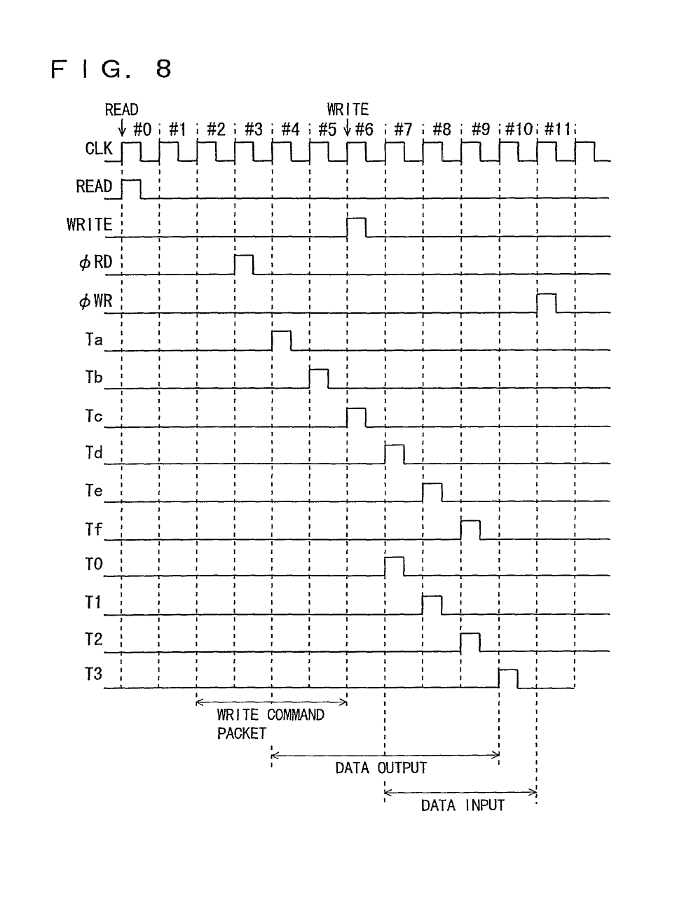

FIG. 8 is a timing chart representing an operation of bit-width expansion circuit 12 and bit-width reduction circuit 15 in performing the data writing and reading shown in FIG. 3. Now, the data read and write operations will be described with reference to FIG. 8.

In cycle #0 of the clock signal CLK, the read operation mode instructing signal READ is activated according to the read command packet. The read activation signal φRD is activated after two clock cycles since activation of the read operation mode instructing signal READ, i.e., in clock cycle #3. Latch circuits 31a to 31f shown in FIG. 7 responsively latch the internal data bits on internal data bus 13.

Thereafter, the transfer clock cycles Ta to Tf are sequentially activated from clock cycle #4, and the latch data of latch circuits 31a to 31f are applied to output buffer 16 through the respective transfer gates 30a to 30f.

Since the write command packet is applied over four clock cycles, the write command packet is applied over clock cycles #2 to #5. According to the write command packet, the write operation mode instructing signal WRITE is activated in clock cycle #6. In response to activation of the write operation mode instructing signal WRITE, write transfer control circuit 22 shown in FIG. 5 is activated to sequentially activate the transfer clock signals T0 to T3 over clock cycles #7 to #10. According to the transfer clock signals T0 to T3, the write data is latched in latch circuits 21a to 21d shown in FIG. 5. In clock cycle #11, the write activation signal φWR is activated, whereby the data bits latched in latch circuits 21a to 21d are transferred in parallel onto internal data bus 13.

Accordingly, in clock cycles #4 and #5, both first and second buses 3 and 4 transfer the signal and data. Moreover, in clock cycles #7 to #9, both first and second buses 3 and 4 transfer the data bits. Thus, an unoccupied time period of the buses is reduced, whereby the data transfer efficiency can be improved.

As shown in FIG. 8, when the transfer clock signals Ta to Tf are activated, the read data bits have been latched in latch circuits 31a to 31f (see FIG. 7), and the internal column selection for the read operation is completed. Therefore, the column circuit is reset according to the read operation activation signal φRD, and then, the write activation signal φWR is activated again in clock cycle #11. The internal column selection is performed in generation of the transfer clock signals Ta to Tf and T0 to T3. In FIG. 8, the column selection requires two clock cycles. Therefore, even if the write operation mode instructing signal WRITE is activated and the internal column selection for the write operation is responsively performed in sequential activation of the transfer clock signals Ta to Tf, conflict of the internal data does not occur.

In the case where the memory IC includes a plurality of banks, the bus utilization efficiency can be improved by accessing the banks in the interleaved manner.

Write transfer control circuit 22 of FIG. 5 and read transfer control circuit 32 of FIG. 7 can operate independently of each other. Such an independent operation allows the write data and read data to be simultaneously transferred onto the first and second buses.

If the write data and the read data may possibly internally conflict with each other (if the column latency for the data writing and reading is longer than the number of clock cycles between application of the command packets), a contention avoidance circuit is provided for allowing the subsequent internal column selection operation to be performed only after one internal column selection operation is completed. Thus, such internal data conflict on the data bus can be prevented.

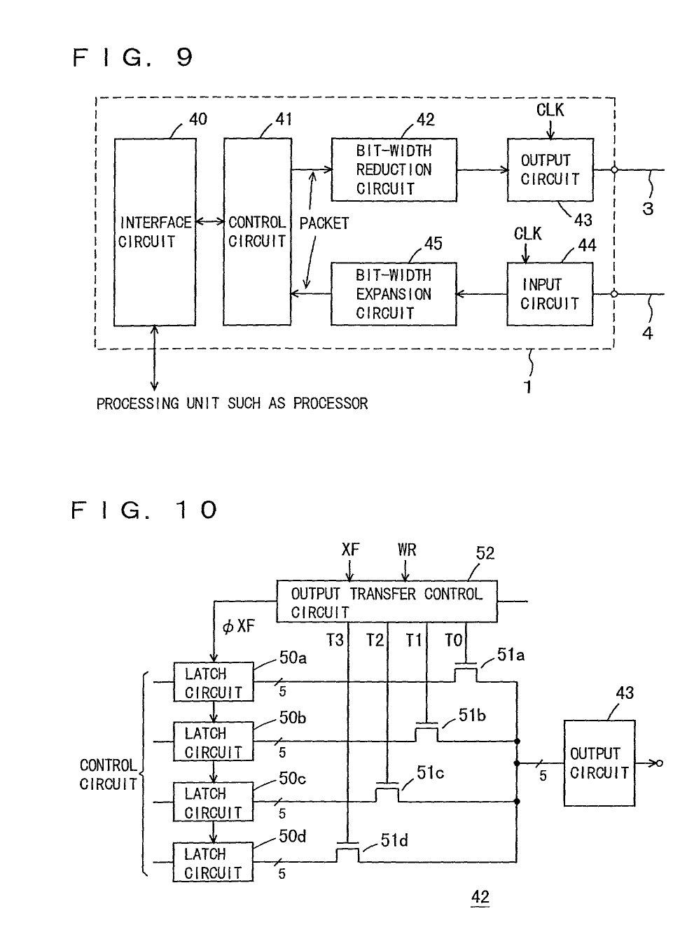

FIG. 9 is a diagram schematically showing the structure of memory controller 1 shown in FIG. 1. In FIG. 9, memory controller 1 includes an interface circuit 40 for accessing a processing unit such as a processor, a control circuit 41 coupled to interface circuit 40 for producing a required packet according to an access request from the processing unit to the memory IC, a bit-width reduction circuit 42 for receiving the packet from control circuit 41 and reducing the bit width thereof, an output circuit 43 for transmitting the packet reduced by bit-width reduction circuit 42 onto first bus 3 in synchronization with the clock signal CLK, an input circuit 44 for taking in the data applied from second bus 4 in synchronization with the clock signal CLK, and a bit-width expansion circuit 45 for converting the data bits from input circuit 44 into a data packet of a prescribed bit-width for application to control circuit 41.

Control circuit 41 determines the timing at which the read data is returned in response to the data read instruction, according to the distance to an accessed memory IC (in the case where a plurality of memory ICs are provided), and activates input circuit 44 accordingly. Bit-width reduction circuit 42 and bit-width expansion circuit 45 are activated under the control of control circuit 41. In this memory controller 1, the bit width of the packet to be transmitted/received and the number of clock cycles therefor are adjusted according to the bit widths of first and second data buses 3 and 4. Thus, change in bit width of data buses 3 and 4 can be easily accommodated.

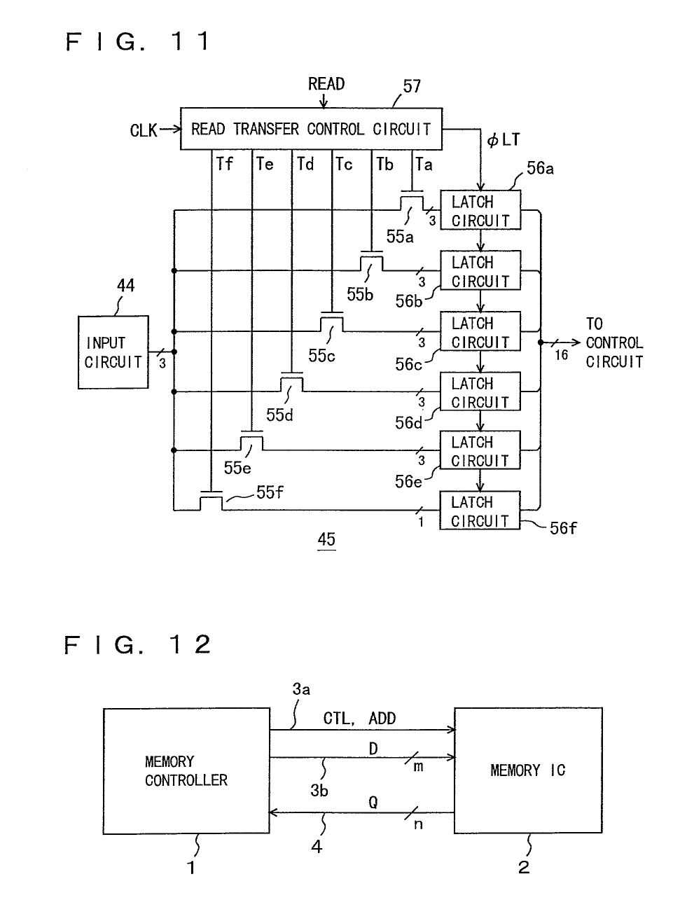

FIG. 10 is a diagram schematically showing the structure of bit-width reduction circuit 42 shown in FIG. 9. In FIG. 10, bit-width reduction circuit 42 includes latch circuits 50a to 50d for receiving the command packet and the write data packet from control circuit 41 in a unit of a prescribed number of bits (e.g., in four bit units) for latching, and transfer gates 51a to 51d provided corresponding to the respective latch circuits 50a to 50d for transferring the latched signals/data bits of the corresponding latch circuits 50a to 50d to output circuit 43 according to the transfer clock signals T0 to T3 from an output transfer control circuit 52.

All the bits of the command packet are applied in parallel to latch circuits 50a to 50d and latched therein. Output transfer control circuit 52 activates a transfer activation signal φXF according to a transfer instruction signal XF and a write instruction signal WR from control circuit 41. After the command bits and data bits are latched in latch circuits 50a to 50d, output transfer control circuit 52 sequentially activates the transfer clock signals T0 to T3. Accordingly, the command packet is transferred in five bit units over four cycles. In the case of the data write operation, the write data is then transferred in five bit units through output circuit 43. When the data read operation is instructed, the write instruction signal WR is inactive, and output transfer control circuit 52 sequentially activates the transfer clock signals T0 to T3 only after latching the read command packet in latch circuits 50a to 50d. Thus, only the read command packet is transferred. The positions of the write data bits are also predetermined under the control of control circuit 41, and the command packet signals and data bits at the prescribed positions are stored in latch circuits 50a to 50d, respectively.

FIG. 11 is a diagram schematically showing one example of the structure of bit-width expansion circuit 45 shown in FIG. 9. In FIG. 11, bit-width expansion circuit 45 includes transfer gates 55a to 55f coupled in parallel to input circuit 44, latch circuits 56a to 56f provided corresponding to the respective transfer gates 55a to 55f, and a read transfer control circuit 57 responsive to activation of the read operation mode instructing signal READ for activating a transfer instruction signal φLT after the column latency plus the data propagation delay time plus the number of clock cycles for data input. The data bits latched in latch circuits 565a to 56f are applied in parallel to the control circuit in response to activation of the transfer instruction signal φLT. The 3-bit read data is sequentially transferred from the memory IC to input circuit 44.

When the read operation mode instructing signal READ from control circuit 41 is activated, read transfer control circuit 57 first activates transfer clock signals Ta to Tf sequentially. Transfer gate 55f, which is coupled to a prescribed internal output node of input circuit 44, transfers 1-bit data. Therefore, latch circuits 56a to 56e each stores 3-bit data, and latch circuit 56f stores 1-bit data. When the data bits transferred through input circuit 44 are transferred to latch circuits 56a to 56f and latched therein, read transfer control circuit 57 activates the transfer instruction signal φLT. Thus, the 16-bit data latched in latch circuits 56a to 56f is applied in parallel to control circuit 41.

By activating the transfer clock signals Ta to Tf in the memory controller in the same order as the activation order of the transfer clock signals Ta to Tf in the memory IC, the data bits can be applied to control circuit 41 without changing their positions from those of the internal read data (16 bits) read in the memory IC. In the case where memory controller 1 and memory IC 2 each internally processes the 16-bit data, the data is transferred through the 5-bit first bus and the 3-bit second bus. Thus, the bus utilization efficiency can be improved, and the data transfer can be performed efficiently.

In the foregoing description, the number of bits of the write data transferred through the first bus is larger than that of the read data. For example, however, in the case where the read operation is performed frequently, second data bus 4 may have a larger bit width than that of first data bus 3.

Moreover, in the foregoing description, the 16-bit command is transferred in 4-bit packet units over four clock cycles, and the 16-bit data is transferred. However, such bit widths are by way of example only, and for example, a 32-bit or 64-bit command and data may be transferred. Moreover, the internal data bus may have a bit width other than 16 bits. For example, the internal data bus may have a 64- or 256-bit width.

It should be appreciated that the command and address are converted in bit width for application to the command decoder and address decoder.

### Modification

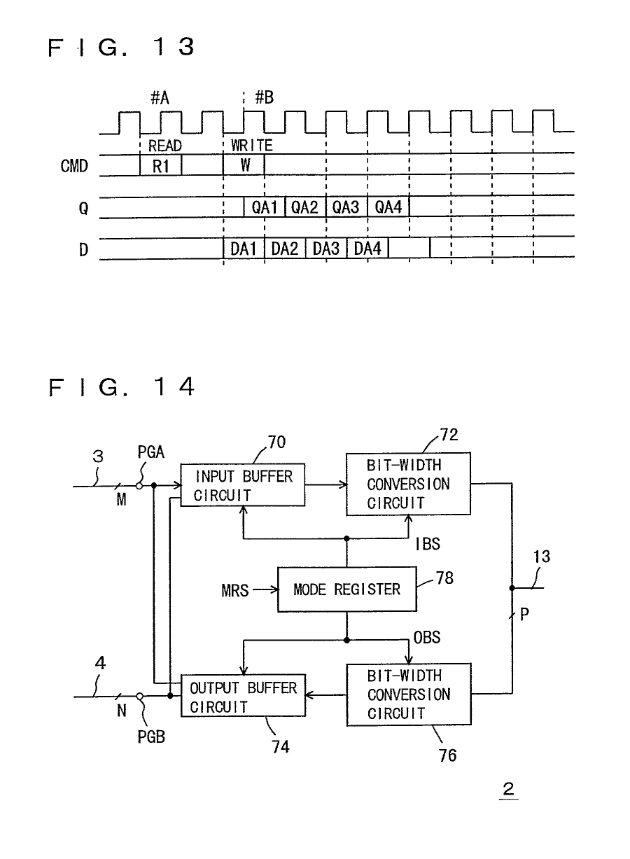

FIG. 12 is a diagram schematically showing the structure of a modification of the memory system according to Embodiment 1 of the present invention. In FIG. 12, memory controller 1 and memory IC 2 are coupled to each other through a control/address bus 3a, a write data bus 3b and a read data bus 4. Write data bus 3b has an m-bit width, and read data bus 4 has an n-bit width. The bit widths m and n of data buses 3b and 4 are different from each other. Control/address bus 3a has a fixed bit width. In such a read/write-separated structure as well, the bus utilization efficiency can be improved by setting the bit widths m and n of data buses 3b and 4 to appropriate values. In this case as well, in memory controller 1 and memory IC 2, a bit-width expansion circuit and a bit-width reduction circuit are similarly provided for the data bits. Such a bit-width expansion/reduction circuit is not provided for control/address bus 3a.

FIG. 13 is a timing chart representing the data write/read operation of the memory system shown in FIG. 12. In clock cycle #A, a read command R1 instructing the data reading is applied. The column latency is two, and data QA1 to QA4 are sequentially read from clock cycle #B. These data are smaller in a bit width than that of the internal data bus of the memory IC. A write command W instructing the data writing is applied in clock cycle #B. In writing the data, write data DA1 to DA4 are applied through write data bus 3b from clock cycle #B.

In the memory IC, all the data bits have been latched in the internal latch circuitry, and the internal column selection operation has been completed in clock cycle #B. Accordingly, even if the write command W is applied in clock cycle #B and the write data DA1 to DA4 are sequentially internally latched, this does not adversely affect the column selection operation for reading a memory cell data. When the internal column selection operation for the read command is completed, the data column selection for the write command is then performed. After the data bit DA4 is stored, the data is internally written to the selected memory cells.

By separately providing the write data bus and the read data bus, the write data bits and the read data bits can be transferred simultaneously. It is assumed that, in the structure of FIG. 13, the internal data bus has a 256-bit width and 32-bit data is selected for input/output in a data input/output circuit portion. For example, if the read operation is performed frequently, the bit width of the read data bus is set to 48, and the bit width of the write data bus is reduced to 16. The total bit width of the write data bus and read data bus remains unchanged. Thus, in the system in which the read operation is performed frequently, the read operation is efficiently performed at a high speed. In the case where the write operation is performed frequently, the bit width of the write data bus is set to a value larger than that of the read data bus. In this case as well, the total bit width of the read data bus and write data bus is not changed.

Accordingly, in the case where the number of bits of the data which can be internally transferred within the memory IC is smaller than that of the data which can be transferred outside the memory IC, efficient data transfer can be achieved by applying the present invention. In the case of the structure having a 256-bit internal bus and a 32-bit external bus, a decoder for performing 256:32 selection within the memory IC is deactivated, and instead, set in to the state of simultaneously selecting 256 bits. Thus, the 256-bit data can be latched and read to the outside in 48 bit units. Moreover, by receiving the write data in 16 bit units and performing serial/parallel conversion thereof, the internal write data can be transferred onto the 256-bit data bus.

As has been described above, according to Embodiment 1 of the present invention, the bus for transferring the write data is provided separately from the bus for transferring the read data, and their bit-widths are made different from each other. The bus widths can be efficiently set according to the applications, whereby data transfer can be efficiently performed with improved bus utilization efficiency.

### Embodiment 2

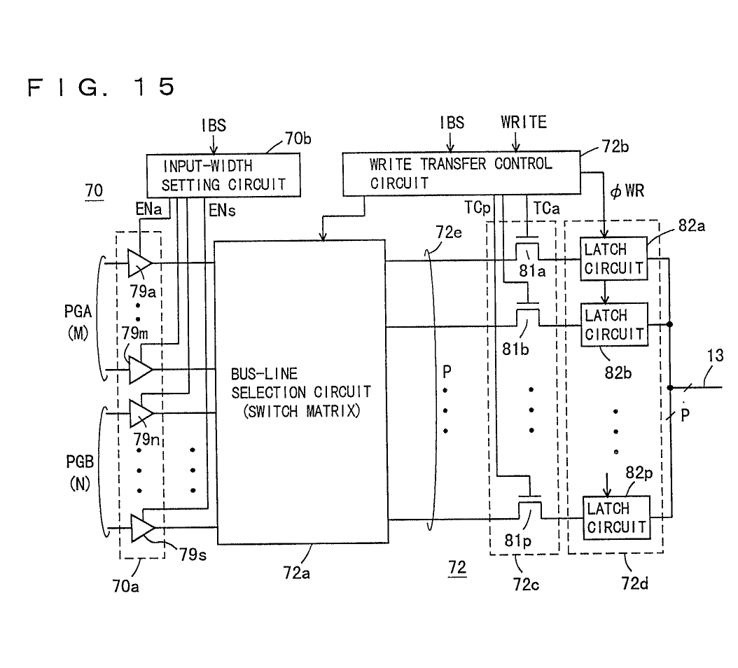

FIG. 14 is a diagram schematically showing the structure of a main part of a memory IC according to Embodiment 2 of the present invention. In FIG. 14, memory IC 2 includes an input buffer circuit 70 coupled to a fist bus 3 through a pin terminal group PGA and coupled to a second bus 4 through a pin terminal group PGB, a bit-width conversion circuit 72 for converting the bit width of output data from input buffer circuit 70 for transmission onto an internal data bus 13, an output buffer circuit 74 coupled to pin terminal groups PGA and PGB, a bit-width conversion circuit 76 for converting the bit width of P-bit data read onto internal data bus 13 into the bit width of output buffer circuit 74 to transfer the internal read data, and a mode register 78 for setting the respective bit widths of input buffer circuit 70 and bit-width conversion circuit 72 as well as the respective bit widths of output buffer circuit 74 and bit-width conversion circuit 76.

Mode register 78 takes in the data applied to a prescribed pin terminal of pin terminal groups PGA and PGB in response to a mode register set command MRS (this path is not shown), and produces an input data bit number setting signal IBS and an output data bit number setting signal OBS. The bit width of input buffer circuit 70 is set by the input data bit number setting signal IBS, and the converted bit width of bit-width conversion circuit 72 is set according to the bit widths of input buffer circuit 70 and internal data bus 13. The bit width of output buffer circuit 74 is set by the output data bit number setting signal OBS, and the processing contents of the bit-width conversion of bit-width conversion circuit 76 are also set by the output data bit number setting signal OBS.

By changing the respective numbers of bits of the write data and read data according to the data stored in mode register 78 as shown in FIG. 14, the number of bits of the read data is increased when the read operation is successively performed in the data processing in the processor or the like, and the number of bits of the write data is increased in the processing mode in which the write operation is performed frequently. In this case, however, the bit width P of internal data bus 13 must be larger than the total bit width (M+N) of data buses 3 and 4. The total number of pin terminals M+N is constant.

Since the bit widths of bit-width conversion circuits 72 and 76 as well as the bit widths of input buffer circuit 70 and output buffer circuit 74 are programmable, the number of data bits can be set to an optimum value according to the processing contents. As a result, efficient data transfer can be realized.

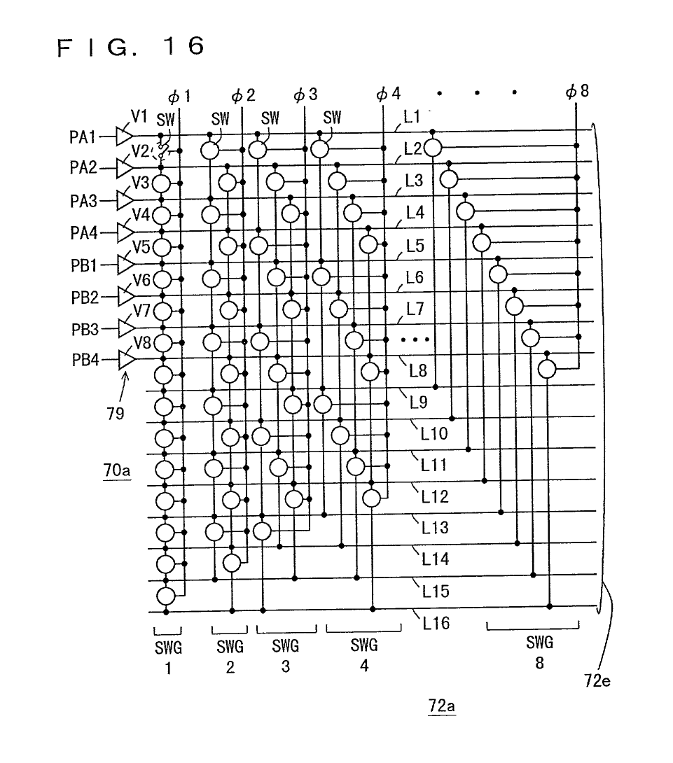

FIG. 15 is a diagram schematically showing the structure of input buffer circuit 70 and bit-width conversion circuit 72 shown in FIG. 14. In FIG. 15, input buffer circuit 70 includes an input circuit 70a coupled to pin terminal groups PGA and PGB, and an input-width setting circuit 70b for setting the bit width of input circuit 70a according to the input bit width setting signal IBS. Input circuit 70a includes tri-state buffer circuits 79a to 79m coupled in parallel to M-bit terminal group PGA, and tri-state buffer circuits 79n to 79s coupled in parallel to N-bit terminal group PGB. Tri-state buffer circuits 79a to 79s are selectively activated according to enable signals ENa to Ens respectively from input-width setting circuit 70b. Input-width setting circuit 70b decodes the input bit width setting signal IBS to selectively activate the enable signals ENa to ENs.

Bit-width conversion circuit 72 includes a bus-line selection circuit 72a for coupling (M +N)-bit bus lines from input circuit 70a to a P-bit internal signal line group 72e, a transfer circuit 72c for transferring a P-bit output signal of bus-line selection circuit 72a, a write latch circuit 72d for latching the data bits transferred from transfer circuit 72c to transfer the latched data bits in parallel onto P-bit internal data bus 13, and a write transfer control circuit 72b for controlling the respective operations of bus-line selection circuit 72a, transfer circuit 72c and write latch circuit 72d.

Bus-line selection circuit 72a, of which structure is specifically described later, is formed by a switch matrix, and selectively couples the (M+N)-bit tri-state buffers to P-bit signal line group 72e according to a data bit width setting signal from write transfer control circuit 72b.

Transfer circuit 72c includes transfer gates 81a to 81p provided corresponding to the respective signal lines of P-bit internal signal line group 72e. Conduction/non-conduction of transfer gates 81a to 81p is individually controlled by write transfer control circuit 72b.

Write latch circuit 72d includes latch circuits 82a to 82p provided corresponding to the respective transfer gates 81a to 81p. Latch circuits 82a to 82p latch the data applied thereto, and transfer the latching data in parallel onto internal data bus 13 according to a write activation signal φWR from write transfer control circuit 72b.

By activating the transfer gates in a unit of bits equal to the bit width of the input data to transfer circuit 72c, required data can be latched in write latch circuit 72d. In other words, write transfer control circuit 72b sequentially activates transfer clock signals TCa to TCp in a unit of bits equal to the input bit width, according to the input data bit width setting signal IBS.

FIG. 16 is a diagram showing one example of the structure of bus-line selection circuit 72a shown in FIG. 15. FIG. 16 shows an exemplary structure in which the total number of bits of terminal groups PGA and PGB is 8 bits, and bit width P of internal data bus 13 is 16 bits.

In FIG. 16, bus-line selection circuit 72a includes signal lines L1 to L16 coupled to internal signal line group 72e, and switching circuits SWG1 to SWG8 including switching elements SW provided corresponding to signal lines L1 to L16.

Switching circuit SWG1 includes a switching element SW for coupling signal line L1 to signal lines L2 to L16 in response to a selection signal φ1. This switching element SW may be formed either by a transfer gate or by a transmission gate. Switching circuit SWG2 includes a switching element group for connecting signal line L1 to signal lines L3, L5, L7, L9, L11, L13 and L15 in response to a selection signal φ2, and a switching element group for connecting signal line L2 to signal lines L4, L6, L8, L10, L12, L14 and L16 in response to the selection signal φ2.

Switching circuit SWG3 includes a switching element group for connecting signal line L1 to signal lines L4, L7, L10, L13 and L16 in response to a selection signal φ3, a switching element group for connecting signal line L2 to signal lines L5, L8, L11 and L14 in response to the selection signal φ3, and a switching element group for connecting signal line L3 to signal lines L6, L9, L12 and L15 in response to the selection signal φ3.

Switching circuit SWG4 includes a switching element group for connecting signal line L1 to signal lines L5, L9 and L13 in response to a selection signal φ4, a switching element group for connecting signal line L2 to signal lines L6, L10 and L14 in response to the selection signal φ4, a switching element group for connecting signal line L3 to signal lines L7, L11 and L15 in response to the selection signal φ4, and a switching element group for connecting signal line L4 to signal lines L8, L12 and L16 in response to the selection signal φ4.

Other switching circuits including switching element groups are similarly arranged according to the bit width of input data. Finally, switching circuit SWG8 includes a switching element group for connecting signal lines L1 to L8 to respective signal lines L9 to L16 in response to a selection signal φ8.

By selectively rendering the switching circuits conductive according to the data bit width, bus-line connection depending on the bit width of the input data can be realized in bus-line selection circuit 72a according to the selection signals φ1 to φ8.

In input circuit 70a, tri-state buffer circuits V1 to V8 (79) are provided for pin terminals PA1 to PA4 and PB1 to PB4. Tri-state buffer circuits V1 to V8 are selectively activated depending on the bit width of the input data. The tri-state buffer(s) in the inactive state is in an output high-impedance state. Accordingly, even when signal lines L1 to L16 are selectively connected by switching elements SW, the non-selected tri-state buffer(s) does not adversely affect the data-bit transfer.

The selection signals φ1 to φ8 are selectively activated by decoding the input bit width setting signal IBS.

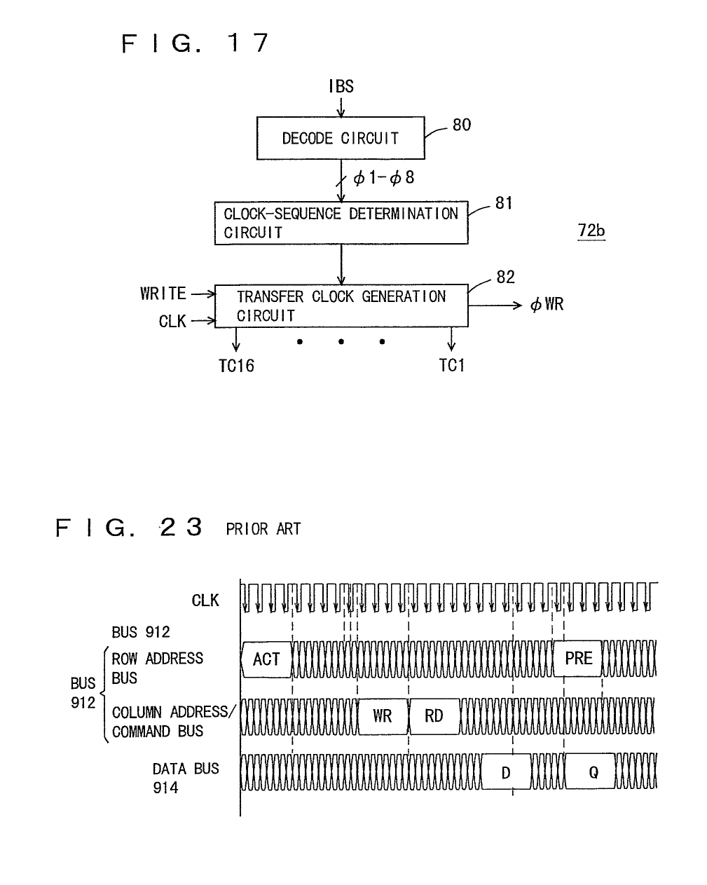

FIG. 17 is a diagram schematically showing the structure of write transfer control circuit 72b shown in FIG. 15. In FIG. 17, write transfer control circuit 72b includes a decode circuit 80 for decoding the input data bit number setting signal IBS to produce the selection signals φ1 to φ8, a clock-sequence determination circuit 81 for determining a clock generation sequence according to the selection signals φ1 to φ8, and a transfer clock generation circuit 82 for generating the transfer clock signals TC1 to TC16 in response to a write operation mode instructing signal WRITE and clock signal CLK according to the clock generation sequence determined by clock-sequence determination circuit 81, as well as generating the write activation signal φWR.

Clock sequence determination circuit 81 is formed by, for example, a barrel shifter, and determines the generation sequence of the transfer clock signals TC1 to TC16 according to the selection signals φ1 to φ8. For example, the shift width of the barrel shifter is determined according to the selection signals φ1 to φ8. For example, when the selection signal φ1 is activated, a shift register performs a normal shift operation so as to sequentially activate the transfer clock signals TC1 to TC16. When the selection signal φ8 is activated, the shift width of the barrel shifter is set so as to perform an 8-bit shift operation. In this case, the transfer clock signals TC1 to TC8 are first activated at a time in transfer clock generation circuit 82 according to the clock signal CLK, and then, the transfer clock signals TC9 to TC16 are activated at a time. Even when the bit width of the input data is changed, the generation sequence of the transfer clock signals can be easily determined by clock sequence determination circuit 81 of write transfer control circuit 72b as shown in FIG. 17. Thus, the input data bits on internal signal line group 72e can be accurately latched. Transfer clock generation circuit 82 activates the write activation signal φWR after all the transfer clock signals TC1 to TC16 are activated.

FIG. 18 is a diagram schematically showing the structure of bit-width conversion circuit 76 and output buffer circuit 74 shown in FIG. 14. In FIG. 18, bit-width conversion circuit 76 includes latch circuits 92a to 92p for latching the P-bit data on internal data bus 13 in parallel, a transfer circuit 76c for transferring the latched data bits in latch circuits 92a to 92p according to transfer clock signals XCa to XCp from an output transfer control circuit 76b, and a bus-line selection circuit (switch matrix) 76d for selectively transmitting the data bits transferred from transfer circuit 76c onto an internal signal line group 76e to output buffer circuit 74. Output transfer control circuit 76b produces the transfer clock signals XCa to XCp and sets a connection path in bus-line selection circuit 76d, according to the output bit width setting signal OBS and a read operation mode instructing signal READ.

Output buffer circuit 74 includes an output circuit 74a for selectively transmitting the data bits from bus-line selection circuit 76d to pin terminal groups PGA and PGB, and an output-width setting circuit 74b for selectively setting the output bit width of output circuit 74a according to the output data bit number setting signal OBS.

Output circuit 74a includes tri-state buffer circuits 94a to 94m provided corresponding to the respective pin terminals of pin terminal group PGA, and tri-state buffer circuits 94n to 94s provided corresponding to the respective pin terminals of pin terminal group PGB. Tri-state buffer circuits 94a to 94s are selectively activated according to enable signals OENa to OENs respectively from output-width setting circuit 74b. The bit width of the output data is determined by the enable signals OENa to OENs.

In bus-line selection circuit 76d, the transfer data bits from transfer circuit 76c are selectively coupled to the activated tri-state buffer circuit(s) according to the bit width of the output data. In other words, in a read latch circuit 76a, latch circuits 92a to 92p latch the internal data bits in parallel according to a read activation signal φRD. Then, the transfer clock signals XCa to XCp are selectively sequentially activated according to the bit width of the output data, whereby transfer gates 91a to 91p are activated into the conductive state. Thus, the data transfer according to the bit width of the output data can be performed between read latch circuit 76a and output circuit 74a.

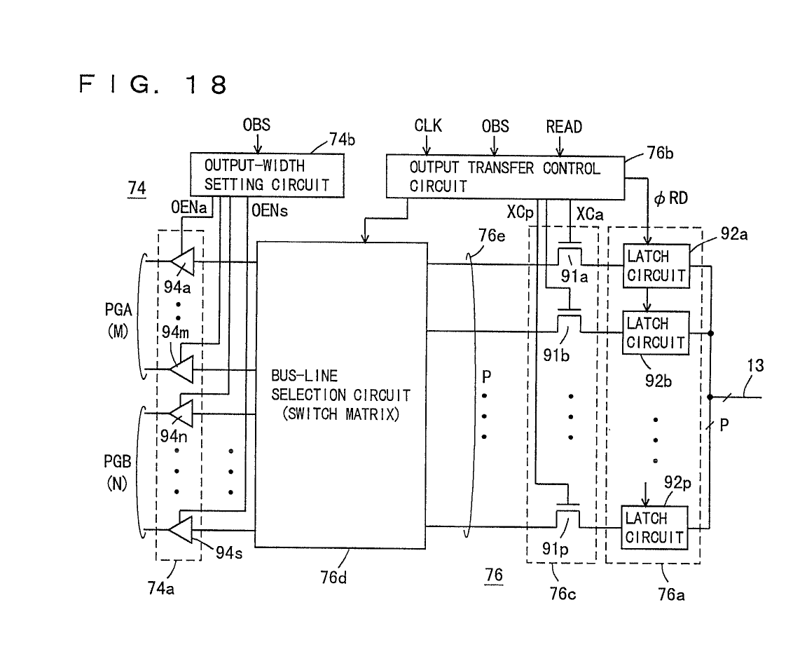

FIG. 19 is a diagram showing one example of the structure of bus-line selection circuit 76d shown in FIG. 18. FIG. 19 also shows an exemplary structure in which internal data bus 13 has a 16-bit width and each of pin terminal groups PGA and PGB is 4 bits.

In FIG. 19, bus-line selection circuit 76d includes tri-state buffer circuits F1 to F8 provided corresponding to pin terminals PB4 to PB1 and PA4 to PA1, and switching circuits OSWG1 to OSWG8 for selectively coupling internal signal line group 76e to tri-state buffer circuits F1 to F8 according to selection signals Oφ1 to Oφ8. The structure of switching circuits OSWG1 to OSWG8 corresponds to that of switching circuits SWG1 to SWG8 included in bus-line selection circuit 72a shown in FIG. 16. Switching elements SW of switching circuits OSWG1 to OSWG8 are selectively rendered conductive by the selection signals Oφ1 to Oφ8 and couple the activated tri-state buffer circuit(s) F1 to F8 to internal signal lines of the internal signal line group 76e.

Terminals PB4 to PB1 of pin terminal group PGB are sequentially coupled to signal lines LL1 to LL4, and pin terminals PA4 to PA1 of pin terminal group PGA are sequentially coupled to signal lines LL5 to LL8. The write data and read data are transferred in parallel, and a single pin terminal serves as a pin terminal for receiving the write data or outputting the read data. As the bit width of the write data is increased from pin terminal PA1 toward PA4 and from pin terminal PB1 toward PB4, the bit width of the read data is correspondingly increased from pin terminal PB4 toward PB1 and from pin terminal PA4 toward PA1. Thus, contention of the data bits is prevented.

The generation sequence of the selection signals Oφ1 to Oφ8 is the same as that of the selection signals for the write data bits. This is implemented by the same structure as that shown in FIG. 18. After the read activation signal φRD is activated, the transfer clock signals XCa to XCp are activated in a prescribed sequence according to the selection signals Oφ1 to Oφ8.

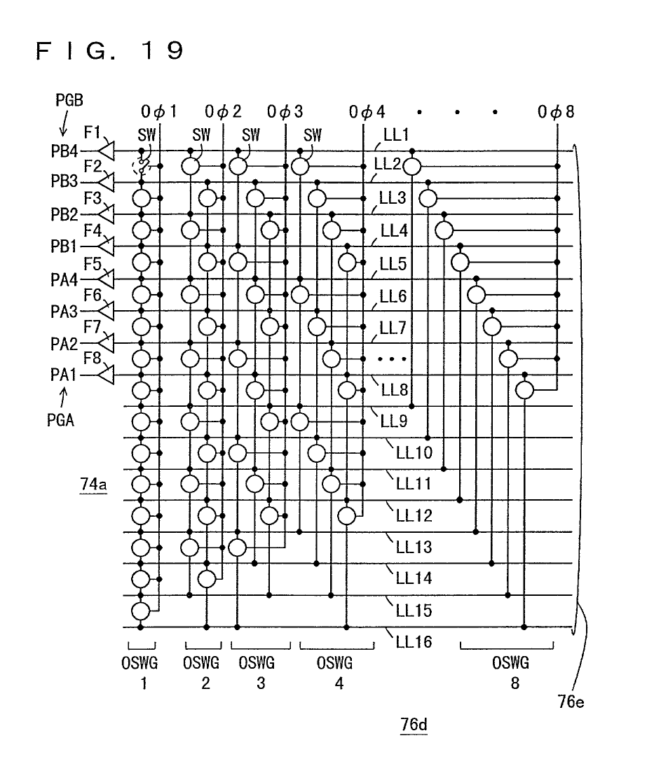

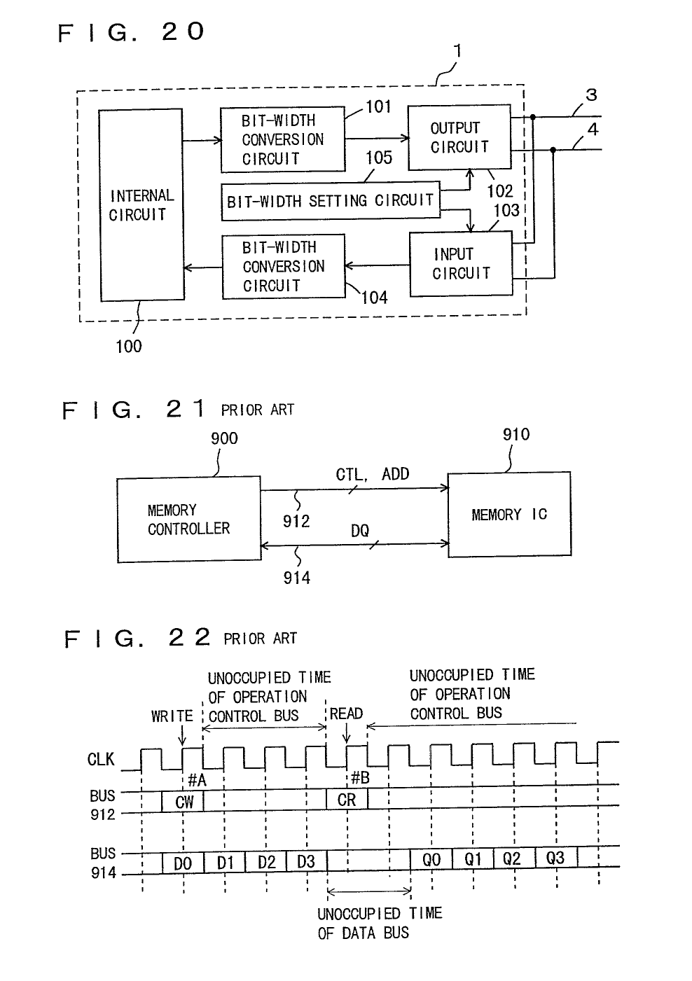

FIG. 20 is a diagram schematically showing the structure of memory controller 1 according to Embodiment 2 of the present invention. In FIG. 20, memory controller 1 includes an internal circuit 100 for performing an operation required for access to the memory IC, a bit-width conversion circuit 101 for converting the bit width of a packet from internal circuit 100, an output circuit 102 for transmitting the signal/data bits from bit-width conversion circuit 101 onto bus 3 and/or 4, an input circuit 103 for receiving the data bits from bus 3 and/or 4, a bit-width conversion circuit 104 for converting the bit width of the data bits from input circuit 103 for application to internal circuit 100, and a bit-width setting circuit 105 for setting the respective bit widths of output circuit 102 and input circuit 103.

Bit-width conversion circuit 101 performs bit-width conversion in a manner opposite to that of the bit-width conversion performed in bit-width conversion circuit 72 for the data write operation in the memory IC. Bit-width conversion circuit 104 performs bit-width conversion in a manner opposite to that of the bit-width conversion performed in bit-width conversion circuit 76 for the data output operation in the memory IC. Accordingly, bit-width conversion circuits 101 and 104 have the same structure as that of bit-width conversion circuit 76 for reading the data as shown in FIG. 19 and bit-width conversion circuit 72 for writing the data as shown in FIG. 16, respectively (but the bit widths are different). Bit-width setting circuit 105, which corresponds to the mode register of the memory IC, applies an enable signal to output circuit 102 and input circuit 103 to selectively activate an output buffer circuit and an input buffer circuit. Output circuit 102 and input circuit 103 have the same structure as that of the output circuit and input circuit of the memory IC, respectively.

By using the structure of memory controller 1 shown in FIG. 20 to perform the bit-width conversion in bit-width conversion circuits 101 and 104, the bit width of the data can be changed according to the operation mode. For example, in the case where the data transfer is performed in the burst mode, the bit width of the data to be transferred is set to the maximum value, whereby the data transfer can be performed efficiently.

It should be noted that Embodiment 2 can also be applied to the structure in which a control signal and an address signal are transmitted through a bus separate from that for write data.

Moreover, the memory IC used in the memory system is not limited to a memory operating in synchronization with the clock signal CLK. The present invention can be applied as long as the write data and the read data are transferred through separate bus lines.

The bit width of the data is herein changed by 1 bit. However, in the structure of transferring 32-bit data for example, the bit width may be changed by 4 bits. The bit width can be changed by such a plurality of bits by regarding each of the signal lines shown in FIGS. 16 and 19 as a 4-bit signal line, for example.

As has been described above, according to the present invention, the number of bits of write data is made different from that of read data. As a result, data transfer can be performed efficiently according to the system environment, whereby a memory system with improved bus utilization efficiency can be implemented.

Although the present invention has been described and illustrated in detail, it is clearly understood that the same is by way of illustration and example only and is not to be taken by way of limitation, the sprit and scope of the present invention being limited only by the terms of the appended claims.

What is claimed is:

1. A semiconductor memory device, comprising:
a plurality of input terminals for receiving write data, a control signal and an address signal; and
at least one output terminal for outputting read data, said read data being allowed to be different in bit width from said write data.

2. The semiconductor memory device according to claim 1, further comprising a data control circuit for changing a number of terminal(s) functioning as the input terminal(s) and a number of terminal(s) functioning as the output terminal(s).

3. The semiconductor memory device according to claim 1, wherein the input terminals are coupled to a first bus, and said at least one output terminal is coupled to a second bus, and each of the first and second buses is a unidirectional bus for transferring a signal or data in one direction.

4. The semiconductor memory device according to claim 1, further comprising:
a write conversion circuit coupled between an internal data bus and the input terminal(s) for converting write data applied to said input terminal(s) into internal write data being equal in bit width to said internal data bus, and outputting said internal write data; and
a read conversion circuit coupled between said internal data bus and the output terminal for converting internal read data read onto said internal data bus into data being equal in bit width to said at least one output terminal, and transferring converted data to said at least one output terminal.

5. The semiconductor memory device according to claim 4, wherein
said write conversion circuit includes a serial/parallel conversion circuit for sequentially receiving write data applied to said input terminal(s), and transferring received write data in parallel onto said internal data bus, and
said read conversion circuit includes a parallel/serial conversion circuit for receiving data of a plurality of bits read in parallel onto said internal data bus, and converting said data of a plurality of bits into serial data to sequentially transfer said serial data to said at least one output terminal.

6. The semiconductor memory device according to claim 5, further comprising a data-bit control circuit for changing a bit width of input data of said serial/parallel conversion circuit and a bit width of output data of said parallel/serial conversion circuit.

7. The semiconductor memory device according to claim 4, further comprising a data-bit control circuit for changing a number of bits of input data of said write conversion circuit and a number of bits of output data of said read conversion circuit.

8. The semiconductor memory device according to claim 4, further comprising a control circuit for operating said write conversion circuit and said read conversion circuit in parallel.

9. A memory system, comprising:
a memory for storing information;
a memory controller for controlling access to said memory;
a first unidirectional bus for transferring write data, a control signal and an address signal from said memory controller to said memory; and
a second unidirectional bus for transferring read data from said memory to said memory controller, said read data being allowed to be different in bit width from said write data.

10. The memory system according to claim 9, wherein said memory includes:
a write circuit for receiving said write data to produce internal write data;
a read circuit for producing said read data from internal read data that is read internally; and
a data-bit changing circuit for changing a number of bits of input data of said write circuit and a number of bits of output data of said read circuit.

11. The memory system according to claim 9, wherein said memory controller includes a circuit for changing a number of bits of said write data and a number of bits of said read data.

12. The memory system according to claim 9, wherein said memory includes circuitry for simultaneously inputting and outputting said write data and said read data.

13. The memory system according to claim 9, wherein said memory controller includes circuitry for simultaneously transferring said write data and said read data.

14. The memory system according to claim 9, wherein said first unidirectional bus transfers the write data, the control signal and the address signal through common data bus lines.

15. The semiconductor memory device according to claim 1, wherein the input terminals receive the write data, the control signal and the address signal at common terminals.
